(19) United States
(12) Patent Application Publication
(10) Pub. No.: US 2023/0217909 A1
(43) Pub. Date: Jul. 13, 2023

(54) Live Crustacean Holding Fishing Device

(71) Applicants: Rick Guirard, North Palm Beach, FL (US); Mark Khan, Lake Worth, FL (US)

(72) Inventors: Rick Guirard, North Palm Beach, FL (US); Mark Khan, Lake Worth, FL (US)

(21) Appl. No.: 17/723,188

(22) Filed: Apr. 18, 2022

Related U.S. Application Data
(60) Provisional application No. 63/176,288, filed on Apr. 18, 2021.
(60) Provisional application No. 63/332,122, filed on Apr. 18, 2022.

(51) Int. Cl. A01K 83/06

(52) U.S. Cl. CPC A01K 83/064

(57) ABSTRACT

A live crustacean holding fishing device is disclosed. The device has a clasp secured to the shank of a fishing hook in a proximity of the start of the arcuate bight of the hook. A ring tab is attached to the clasp via a stretchable hook casing. The components of the fishing device are sized and shaped such that a shrimp may be attached by passing the ring tab over the horn of the shrimp and stretching the hook casing so until the clasp is hooked under the armor plate shell of the shrimp, thereby securing the shrimp to the device, but allowing the shrimp to swim freely.

### CROSS-REFERENCE TO RELATED APPLICATIONS

This is a US non-provision application of U.S. provisional application 63/176,288 entitled “Live shrimp securing fishing lure” filed on Apr. 18, 2021, the contents of which are hereby fully incorporated by reference. This is also a US non-provision application of U.S. provisional application 63/332,122 entitled “Live Crustacean Holding Fishing Device” filed on Apr. 18, 2022, the contents of which are hereby fully incorporated by reference.

### BACKGROUND OF THE INVENTION

### (1) Field of the Invention

The present invention relates to fishing tackle and more particularly to a live crustacean holding fishing device primarily intended as a fishing lure in which a live crustacean such as, but not limited to, a live shrimp, is attached to a fishing hook such that the crustacean is free to swim in the water.

### (2) Description of Related Art

A common method of securing a crustacean such as, but not limited to, a shrimp or a crayfish, to a hook as bait is to pierce the tail of the crustacean with a hook. The disadvantage of such a procedure is that the shrimp or crayfish is short lived and frequently works free of the hook. Some special lure devices have been designed some of which have been patented which encircle the body of the shrimp or minnow. Others encircle the body under tension or pierce the body of the shrimp. Others employ spring action to clamp the body of the shrimp or minnow to the hook.

The relevant prior art includes:

U.S. Pat. No. 3,729,851 issued to Garcia on May 1, 1973, entitled “LIVE SHRIMP SECURING FISHING LURE” that describes a combined fishhook live shrimp holding device primarily designed as a saltwater fishing lure. The device employs a long shank double or treble hook to which is secured adjacent the bight of the hook a shell grasping member. The device is further attached to the shrimp by means of a shrimp horn ring that is secured in position by either spring loading or friction or a combination of both.

Various implementations are known in the art, but fail to address all of the problems solved by the invention described herein. Various embodiments of this invention are illustrated in the accompanying drawings and will be described in more detail herein below.

### BRIEF SUMMARY OF THE INVENTION

An inventive live crustacean holding fishing device is disclosed.

In a preferred embodiment, the live crustacean holding fishing device may include a clasp that may be secured to the shank of a fishing hook in a proximity of the start of the arcuate bight of the hook. A ring tab may be attached to the clasp via a stretchable hook casing.

The components of the fishing device are sized and shaped such that the ring tab may be passed over the horn of a shrimp and the clasp hooked under the armor plate shell of the shrimp, thereby securing the shrimp to the device, but allowing the shrimp to swim freely.

The stretchable hook casing that fits over the shank of the hook may be made of a suitable elastomer such as, but not limited to, 40 durometer silicone rubber.

The ring tab and the stretchable hook casing are preferably formed as an integrated unit.

The clasp may be formed from a suitable material such as, but not limited to, an ABS terpolymer.

Therefore, the present invention succeeds in conferring the following, and others not mentioned, desirable and useful benefits and objectives.

It is an object of the present invention to provide a device that will securely hold a live crustacean with minimum injury thereby encouraging the crustacean to remain a alive.

### BRIEF DESCRIPTION OF THE SEVERAL VIEWS OF THE DRAWINGS

FIG. 1 shows a prior art live shrimp securing fishing lure attached to a shrimp.

FIG. 2 shows a further embodiment of a prior art live shrimp securing fishing lure.

FIG. 3 shows an isometric view of one embodiment of a live crustacean holding fishing device of the present invention.

FIG. 4 shows a side view of one embodiment of a live crustacean holding fishing device of the present invention.

### DETAILED DESCRIPTION OF THE INVENTION

The preferred embodiments of the present invention will now be described with reference to the drawings. Identical elements in the various figures are identified, in so far as possible, with the same reference numerals. The embodiments that are described in detail are provided by way of explanation of the present invention, which is not intended to be limited thereto. In fact, those of ordinary skill in the art may appreciate upon reading the present specification and viewing the present drawings that various modifications and variations can be made thereto.

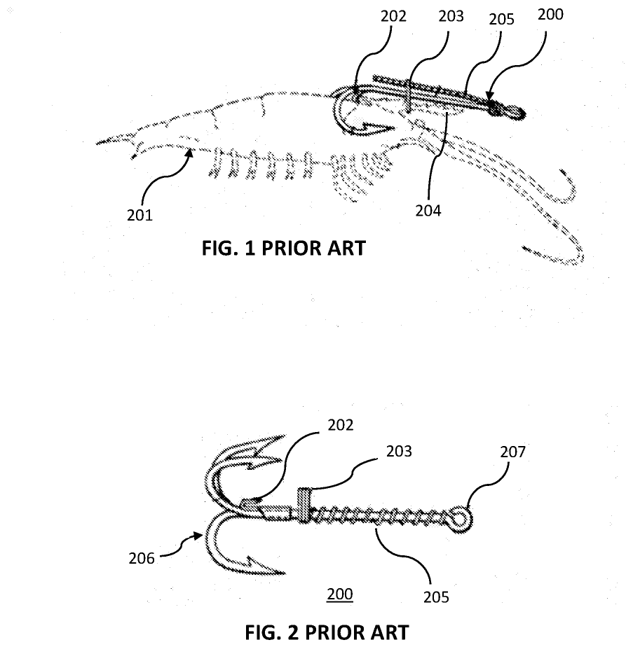

FIG. 1 shows a prior art live shrimp securing fishing lure attached to a shrimp.

The figure is copied from U.S. Pat. No. 3,729,851 issued to Garcia on May 1, 1973, entitled “Live Shrimp Securing Fishing Lure”.

As shown, a shrimp 201 may be attached to a live shrimp hook fishing lure 200. Part of the attachment may be a thin shell grasping member 202 that may be inserted under the body shell of the live shrimp. A horn ring 203 may be attached over the horn of the shrimp 204 held in place by the compression force of a spring 205.

FIG. 2 shows a further embodiment of a prior art live shrimp securing fishing lure 200.

The live shrimp hook fishing lure 200 consist of a treble fishhook 206 to which a thin shell grasping member 202 is attached. The lure may also have a horn ring 203 that may be forced towards the shell grasping member 202 by means of a compression spring 205 that may be attached to the eye 207 of the hook.

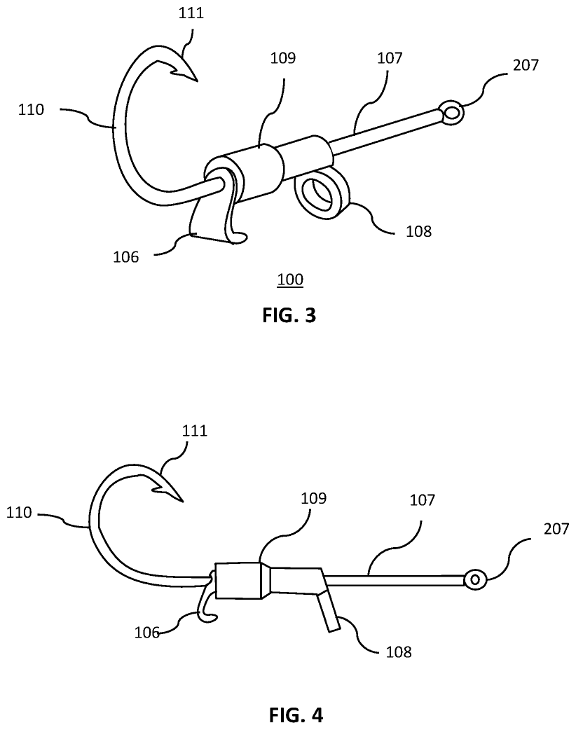

FIG. 3 shows an isometric view of one embodiment of a live crustacean holding fishing device of the present invention.

FIG. 4 shows a side view of one embodiment of a live crustacean holding fishing device of the present invention.

The live crustacean holding fishing device 100 may have a clasp 106 that may be attached to the shank 107 of a fishing hook at a location in a proximity of the start of the arcuate bight 110 of the hook. A stretchable hook casing 109 may be attached by one end to the clasp 106 and at the other end to a ring tab 108.

Such a device may, for instance, be attached to a live shrimp by first passing the ring tab 108 over the horn of the shrimp. The hook may then be pushed toward the back of the shrimp, stretching the stretchable hook casing 109 until the clasp 106 may be hooked under the shell plate of the shrimp.

The stretchable hook casing 109 may be made of any suitable elastomer tubing such as, but not limited to a surgical silicone or a latex rubber tubing. However, in a preferred embodiment, the stretchable hook casing 109 may be made of 40 durometer silicone rubber.

The ring tab 108 may be made of any suitable material, though in a preferred embodiment it may be made from 40 durometer silicon rubber and manufactured as an integral part of the stretchable hook casing.

The clasp 106 may be made of any suitable material, though in a preferred embodiment it may be molded using an ABS terpolymer. The clasp may have a slot that may be fitted to the shank 107 of the hook. The clasp may also, or instead be glued to shank of the hook.

FIG. 4 shows a side view of one embodiment of a live crustacean holding fishing device of the present invention.

FIG. 4 shows a single fishing hook having an eye 207 for attaching a fishing line, a straight shank 107, and a barb 111 at the end of an arcuate bight 110.

The live crustacean holding fishing device may be constructed by having a clasp 106 attached to the shank 107 of the hook in a proximity to the start of the arcuate bight 110. A stretchable hook casing 109 may be attached to the clasp 106 either by gluing or by means of a protrusion on the clasp or a combination thereof. A ring tab 108 may be attached to the stretchable hook casing 109 or may be formed as an integral part of the ring casing.

Although the live crustacean holding fishing device has been described with reference to a single fishing hook, one of ordinary skill in the art may appreciate that the device may also be used on double or treble hooks.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1: A live crustacean holding fishing device, comprising:
a fishing hook;
a clasp secured to the shank of said hook;
a stretchable hook casing attached to said clasp at a first end of said casing, and,
a ring tab connected to said stretchable hook casing at a second end of said casing.

2: The fishing device of claim 1, wherein, said ring tab is sized to be a secure fit to a horn of a shrimp.

3: The fishing device of claim 1, wherein, said stretchable hook casing comprises an elastomer.

4: The fishing device of claim 3, wherein, said elastomer is 40 durometer silicone rubber.

5: The fishing device of claim 1, wherein, said ring tab is integrally formed with said stretchable hook casing.

6: The fishing device of claim 1, wherein, said clasp 106 comprises an ABS terpolymer.
